(19) United States
(12) Patent Application Publication
(10) Pub. No.: US 2007/0113846 A1
(43) Pub. Date: May 24, 2007

(54) Facepiece for a respirator for high performance fixed-wing aircraft crew protection

(75) Inventors: Gary J. Piorkowski, Mayfield, PA (US); William Radzelovage, Newton, NJ (US)

Correspondence Address: COHEN, PONTANI, LIEBERMAN & PAVANE, 551 FIFTH AVENUE, SUITE 1210, NEW YORK, NY, 10176, US

(73) Assignee: Crew Systems Corporation

(21) Appl. No.: 11/474,779

(22) Filed: Jun. 26, 2006

Related U.S. Application Data
(60) Provisional application No. 60/694,449, filed on Jun. 27, 2005.

(51) Int. Cl. A62B 18/08; A62B 17/04

(52) U.S. Cl. 128/201.26; 128/201.22

(57) ABSTRACT

A facepiece for use in a respirator for a pilot. The facepiece includes a separate mask and faceframe, each of which is individually fittable to the user. Once the two pieces are fitted, a mechanism may fixedly connect them to one another, thereby preventing further relative movement therebetween.

### CROSS REFERENCE TO RELATED APPLICATIONS

This application claims priority from U.S. Provisional Patent Application Ser. No. 60/694,449 which was filed on Jun. 27, 2005.

### BACKGROUND OF THE INVENTION

1. Field of the Invention

This application is directed to the field of equipment used by pilots in high-performance fixed-wing aircraft, and, more particularly, to a facepiece used by such pilots in connection with a respirator.

2. Description of the Related Art

Providing breathable air to pilots of high performance aircraft is a difficult problem. First, the air must contain the proper concentration of oxygen to enable the pilot to function. As the pilot flies the aircraft at higher and higher altitudes, the pilot cannot simply rely on ambient air as the source of breathable air, because the oxygen partial pressure decreases at altitude. Second, many fighter/attack aircraft now have as part of their G-protection features positive pressure breathing for G, or PBG with which the pressure of the breathing gas supplied to the pilot may be substantially above ambient pressure. Thus, it is necessary to provide pilots with a reliable supply of breathable air in which both oxygen concentration and pressure are controlled. For standard (no chemical/biological threat) operations, this is normally accomplished by a regulator supplying a suitable airflow to a mask worn by the pilot. Such masks usually cover only the mouth and nose of the pilot. Breathing gas is provided to the pilot through an inlet valve and waste gas is exhausted through an outlet valve.

The fit of such masks is very important, because they must seal well against the face to avoid leakage during pressure breathing operations. Excessive leakage can waste breathing oxygen (in limited supply in many aircraft), may reduce the required in-mask pressure, and may cause vision impairment if leakage is directly into the eyes.

There are also particular problems and difficulties in implementing a chemical/biological respirator for use in fighter aircraft with pressure breathing capability for high-G and/or altitude protection. While the respirator must completely enclose the head and face to protect the wearer's eyes and lungs from external chemical or biological agents, it must have a transparent visor portion in front of the eyes, and an oronasal mask (“mask”) portion covering the mouth and nose which performs the same function as the mask in standard operations with respect to delivering suitable breathing gas to the pilot. In addition, it is highly desirable, though not necessary, to have that portion of the respirator that covers the eyes, nose, and mouth (“facepiece”) be removable. This “removability” feature is for in-flight physiological emergencies (vomiting, for example) and also allows interchangeability of multiple mask sizes with the over-head hood portion, which is also commonly available in multiple sizes. Thus, for example, four sizes of masks can be used with three sizes of hoods without having to stock all different sizes of mask/hood combinations (twelve size combinations in this example). Also, damage to one part of the system (for example, a scratched visor) would not require scrapping the entire respirator but would only require replacing the damaged component.

One method of implementing this removable mask, or facepiece, concept that has proved itself in practice is to attach the mask internally to a more-or-less rigid frame (“faceframe”) covering the entire face, with that portion of the frame anterior to the eyes being a transparent visor. The faceframe has a periphery that is shaped to match the contours of a hood frame so that it may be attached to the hood frame in such a manner that a seal is provided to prevent the entry of contaminated air. The frames are then held together by a latch mechanism, and the seal is provided by means of an elastomeric gasket at the frame to frame interface. Normally, the faceshield frame is attached to a helmet by traditional mask-to-helmet attachments or can be used without a helmet by means of around-head straps to hold the faceshield to the face. Alternatively, a complete faceshield frame/mask/visor assembly can be directly attached to the cowl; in this case, of course, the faceshield is not removable from the cowl assembly without destroying the respirator.

A prior art respirator as described above with the removable facepiece feature has been designed for helicopter pilots by ILC Corp. Another, without the removable facepiece feature, is the AR5 respirator produced by Camlock, a UK manufacturer, and used by the U.S. Navy, as well as Canadian and U.K. aircrews. Both of these respirators, however, suffer from significant drawbacks for use in high performance aircraft.

There are two fundamental problems inherent in using such respirators in fighter aircraft. First, to provide physiological protection against G-force and high altitude, the pressure of the breathing gas inside the mask may be increased dramatically (more than 1.4 psi in extreme cases) above ambient pressure. These protective systems are known as Pressure Breathing for G (PBG) and Pressure Breathing for Altitude (PBA). For either PBG or PBA to be effective, the mask must maintain an excellent seal against the face. This demands that the mask be positioned against the face in the optimum sealing location and orientation on each wearer and held at that location and orientation throughout a flight mission and at maximum PBG or PBA pressures. Second, the visor must be located as close to the eyes as the pilot's brow and zygomatic arches allow. This is necessary both to maximize the wearer's visual field and to minimize interference with proper operation of external (normally helmet-mounted) optical devices.

Because optimum fit location and orientation on a wearer depends strongly on upper nose and jaw configurations, both with infinite variability, the mask's position and orientation (with respect to eye location and Frankfort horizontal plane, for example) varies over a wide range from user to user. Also, the orientation and location of the mask with respect to the location and orientation of the faceframe will vary widely from individual to individual, since the faceframe is positioned against different facial features as opposed to the facial features in contact with the mask.

Consequently, if the mask is rigidly mounted inside the faceframe, neither is likely to fit properly. Conversely, if the mask is soft-mounted inside the faceframe so that it might seek an independent fit, the high internal pressures inherent in PBG and PBA will cause the mask to move away from the face, compromising the mask-to-face seal. This may result in loss of mask pressure, visor fogging during exhalation, and/or direct impingement of leaking gas into the eyes.

To rigidly alter the mask location and orientation within the faceframe during initial fitting to a particular pilot would require elaborate externally-accessible positioning mechanisms, adding significant weight, volume, complexity, and the increased possibility of leaks to the respirator.

There is thus a need in the art for a facepiece for a simplified high-altitude respirator that provides for improved seal and performance.

### SUMMARY OF THE INVENTION

Briefly stated, the invention is directed to a facepiece for use as part of a respirator and for attachment to a hood, the facepiece comprising: a faceframe for mounting the facepiece to a hoodframe or directly to the hood; a visor attached to the faceframe; a mask; means for removably affixing the mask to the faceframe; the mask including: means for receiving a supply of gas for breathing by a user of the facepiece; means for permitting the exhausting of the user's breath; means for removably affixing the faceframe to the hoodframe; and an interface between the faceframe and the mask; whereby the mask and the faceframe may be individually fitted to the user, after which the mask and faceframe may be fixed to each other against relative movement by mechanical means.

The various features of novelty that characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings, in which like numerals designate like elements:

FIG. 1 is a perspective view of a facepiece in accordance with the invention, shown in breakaway from a hood with which it is used; and

FIG. 2 is a cross-section of the facepiece of FIG. 1, shown in place on a user while in use.

### DETAILED DESCRIPTION OF THE PRESENTLY PREFERRED EMBODIMENTS

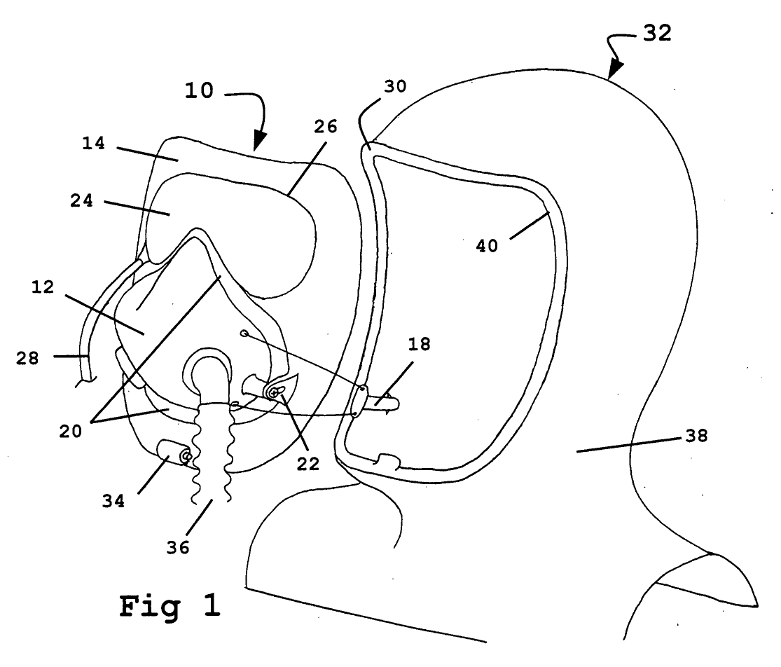

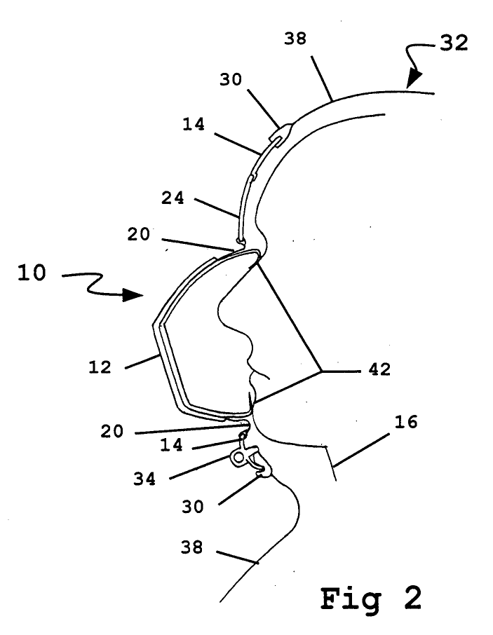

A facepiece in accordance with the invention is shown in the Figures, generally at 10. As shown in FIG. 1, facepiece 10 includes a mask 12 which protrudes through a faceframe 14 and is, during flight, connected directly to a helmet (not shown) worn by a pilot 16 (FIG. 2) through a mechanism 18, similar or identical to mask-helmet attachments with non-respirator flight hardware. Mask 12 is connected to faceframe 14 by means of a thin flexible elastomeric interface 20. Interface 20 is made of any of a number of suitable chemical/biological barrier materials, for example, bromo-butyl. Its flexibility allows required translational and rotational positioning variation between mask 12 and faceframe 14 to achieve required fits on most or all users.

It is preferred that mask 12 and faceframe 14 be individually fitted to provide for the best customized fit therebetween. As part of this process, different sizes and shapes of masks and faceframes may be combined to form the best possible individualized overall fit for facepiece with the face of pilot 16. After the individual elements are chosen, they are fitted individually on pilot 16 to create the tightest seal, and then a mechanism 22 rigidly connects mask 12 and faceframe 14 to prevent any further relative movement therebetween. Mechanism 22 may be any one of a variety of common mechanical designs allowing for free movement between mask 12 and faceframe 14 during fitting, and thereafter maintaining or “locking” the two in the desired positional relationship. Suitable mechanisms may include a slotted tab on the faceframe that interfaces with a threaded boss on the mask via an adjustment screw.

Faceframe 14 contains a transparent visor 24. Visor 24 may be rigidly attached to faceframe 14 or, if it offers any advantages in a particular implementation (for example, the ability to selectively move the visor forward to allow for user-worn vision-corrective spectacles), interface 20 may include an extension 26 (FIG. 1) that extends completely around visor 24, connecting visor 24 to faceframe 14 in a flexible manner.

Visor 24 is supplied with demist air from a clean filtered source. This demist air may be supplied by means of a hose 28 attached to faceframe 14, or it may be supplied from inside the hood, flowing forward and downward, depending on the particular application. Faceframe 14 is connected to a hoodframe 30 of a hood 32 by a latch 34; in a non-removable implementation, faceframe 14 is affixed directly to hood 32.

The combination of mask 12, faceframe 14, mechanism 18, interface 20, mechanism 22, visor 24, demist air hose 28 (if present), latch 34 (if present) and hose 36 for conducting breathing air to the user comprise the facepiece portion of a respirator. The facepiece may also include such features as a lung-powered or emergency demist system, demist air flow restrictors, check valves and connectors as may be required in particular applications.

The remaining portion of the respirator, namely hood 32, consists necessarily of rigid hoodframe 30 and a cowl 38 in a removable facepiece implementation; otherwise, hood 32 and cowl 38 are a single piece. Cowl 38 may or may not contain a neckdam, a head-fitting liner, size adjustments, communications, head ventilation/clean air entry, a valve to vent supplied air to ambient, or any number of other conventional features that a particular application may require.

When faceframe 14 is attached to hoodframe 30, a leakproof seal is formed between the two frames by means of an elastomeric gasket 40, the specific configuration of which is purely conventional. The two frames are held together in a positive manner until manually released by latch 34, which may be of any known type. Both the faceframe/hoodframe/gasket sealing and the latch configurations are amenable to many workable solutions within the capabilities of those skilled in the mechanical engineering art.

Facepiece 10 and hood 32 together form a complete respirator. Facepiece 10 provides for an improved fit and performance of the respirator of which it is a part. The improved performance results, in part, by a seal 42 between mask 12 and user 16, which is permitted by the individualized custom fit of separate mask 12 and faceframe 14 to adjust overall the fit of the respirator to the individualized physiognomy of the pilot to an extent not previously possible. Mask 12 can be attached directly to the pilot's helmet (as in a standard non-respirator mask) for greatly increased positional stability during pressure breathing as compared to one held in place only by the hood 32 with or without a strap around the pilot's head.

Although facepiece 10 has the ability to mechanically clamp faceframe 14 to hoodframe 40 after mask 12 has been properly fit to the individual user, this feature is not necessary for in-aircraft pressure breathing. Its purpose is to maintain a reasonable mask position on the face during emergency ground operations, during which the user will often want to remove the helmet since the helmet is cumbersome when not needed. Under this condition, with mask 12 no longer supported by helmet attachments, hoodframe 40, cowl 38, and (if present) a strap around the head provide sufficient support and maintain sufficient seal to prevent exhalation into and fogging of visor 24.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A facepiece for use as part of a respirator and for attachment to a hood, said facepiece comprising:
a faceframe for mounting said facepiece to said hood;
a visor attached to said faceframe;
a mask having means for receiving a supply of gas for breathing by a user of said facepiece, and means for permitting the exhausting of the user's breath;
means for adjustably affixing said mask to said faceframe; and
an impermeable sealing interface between said faceframe and said mask;
whereby said mask and said faceframe may be individually fitted to said user to provide the best overall fit of said facepiece to said user.

2. The facepiece of claim 1, further comprising means for adjustably affixing said mask to said user.

3. The facepiece of claim 2, wherein said means for adjustably affixing said mask to said user attaches said mask to a helmet worn by said user.

4. The facepiece of claim 1, wherein said interface is a flexible material.

5. The facepiece of claim 1, wherein said interface extends around said visor.

6. The facepiece of claim 1, wherein said means for affixing said mask to said faceframe permits relative movement between said mask and said faceframe during a fitting process.

7. The facepiece of claim 6, wherein said mask and said faceframe may, once said fitting process is complete, be fixed to each other to prevent relative movement between said mask and said faceframe.

8. The facepiece of claim 1, further comprising a seal between said mask and said user.

9. The facepiece of claim 1, wherein said visor is movably attached to said faceframe.

10. A facepiece for use as part of a respirator and for attachment to a hood via a hoodframe, said facepiece comprising:
a faceframe for mounting said facepiece to said hoodframe;
a visor attached to said faceframe;
a mask configured to receive a supply of gas for breathing by a user of said facepiece, and to permit the exhausting of the user's breath;
a first latch that connects said mask to said faceframe;
an impermeable sealing interface between said faceframe and said mask; and
a second latch that connects said faceframe to said hoodframe;
whereby said mask and said faceframe may be individually fitted to said user to provide the best overall fit of said facepiece to said user before said mask is fixed against relative movement by said first latch.

11. The facepiece of claim 10, further comprising a strap for maintaining position of said facepiece on said user.

12. The facepiece of claim 10, wherein said interface is a flexible material.

13. The facepiece of claim 10, wherein said interface extends around said visor.

14. The facepiece of claim 10, wherein said first latch permits relative movement between said mask and said faceframe during a fitting process, and prevents relative movement between said mask and said faceframe once said fitting process is complete.

15. The facepiece of claim 10, further comprising a seal between said mask and said user.

16. The facepiece of claim 10, wherein said visor is movably attached to said faceframe.
